(19) United States
(12) Patent Application Publication
(10) Pub. No.: US 2026/0204190 A1
(43) Pub. Date: Jul. 16, 2026

(54) DISPLAY DEVICE, HEAD-UP DISPLAY AND METHOD FOR CONTROLLING A DISPLAY DEVICE

(71) Applicant: PANASONIC AUTOMOTIVE SYSTEMS CO., LTD., Kanagawa (JP)

(72) Inventor: Giorgio CALVI, Langen (DE)

(73) Assignee: PANASONIC AUTOMOTIVE SYSTEMS CO., LTD., Kanagawa (JP)

(21) Appl. No.: 19/448,633

(22) Filed: Jan. 14, 2026

(30) Foreign Application Priority Data
Jan. 14, 2025 (DE) 102025101054.4

(51) Int. Cl. G09G 3/00; G02B 27/00; G02B 27/01

(52) U.S. Cl. CPC G09G 3/002; G02B 27/0093; G02B 27/0101; G09G 2320/0233; G09G 2320/0626

(57) ABSTRACT

The present invention relates to relates to a display device suitable for a head-up display which employs local dimming. In order to provide for local dimming while avoiding disadvantages involved with conventional approaches, a display device suitable for a head-up display is proposed, including a transmission type display, a light source which is spaced apart from the transmission type display and which includes a plurality of light emitting elements, and a control unit. The control unit receives information on an eye position of a user, and selectively controls the plurality of light emitting elements, so to illuminate a predetermined area corresponding to the eye position of the user through the transmission type display by means of a subset of the light emitting elements, whereas the light emitting elements of the light emitting elements other than that the light emitting elements of the subset are turned off or dimmed.

### CROSS-REFERENCE TO RELATED APPLICATIONS

This application is based on and claims priority under 35 USC 119 from German Patent Application No. 102025101054.4 filed on Jan. 14, 2025, the entire content of which is incorporated herein by reference.

### TECHNICAL FIELD

The present invention relates to a display device, specifically a display device suitable for a head-up display, e.g. a head-up display for use in a moving vehicle, which employs local dimming.

### BACKGROUND ART

Local dimming is an approach in which areas of a backlight for a transmission type display are deactivated (or used with reduced power) which correspond to portions of an image where no image content is present. This allows for a reduction of energy consumption and may address the so-call postcard effect, where due to light leakage a nominally black area of the image is distinguishable from a surrounding dark area of the front scene.

With an increase in the automotive electrification (electrical vehicle), there is an increased desire for reduced consumption of electrical energy within the vehicle.

There is, however, a disadvantage involved with such local dimming, since the use may perceive a different light distribution in the image depending on the position of the head. A conventional approach of addressing such issue is to increase the size of the illuminated area, which, however, has undesired side effects in increasing a halo, reducing contrast and increasing power consumption.

Thus, there is a desire for making use of an approach like local dimming which avoiding disadvantages involved such conventional approaches are indicated above.

### SUMMARY OF INVENTION

According to a first aspect of the invention, a display device suitable for a head-up display is proposed as defined in claim 1, in particular including a transmission type display, a light source which is spaced apart from the transmission type display and which includes a plurality of light emitting elements, and a control unit that receives information on an eye position of a user. The control unit is further configured to selectively control the plurality of light emitting elements, so to illuminate a predetermined area corresponding to the eye position of the user through the transmission type display by means of a subset of the plurality of light emitting elements, whereas the light emitting elements of the plurality of light emitting elements other than that the light emitting elements of the subset are turned off or dimmed.

According to a second aspect of the invention, a method for controlling a display device suitable for a head-up display, the display device includes a transmission type display, a light source which is spaced apart from the transmission type display and which includes a plurality of light emitting elements, and a control unit for controlling the plurality of light emitting elements is proposed as defined in claim 6, in particular a method including the steps of receiving information on an eye position of a user, and selectively controlling the plurality of light emitting elements, so to illuminate a predetermined area corresponding to the eye position of the user through the transmission type display by means of a subset of the plurality of light emitting elements, whereas the light emitting elements of the plurality of light emitting elements other than that the light emitting elements of the subset are turned off or dimmed.

It was realized that the deviating light distribution in the image involved with a movement of the head of the user is caused by a resulting misalignment between the light source and the eye(s) of the user. It was further realized that, rather than by increasing the illuminated area, such misalignment may be addressed by shifting the illuminated portion of the light source for compensating the movement of the user's head. The shifting of the illuminated areas avoids the increase in power consumption and other issues involved with increasing the illuminated area, i.e. the portion of the light source which is used for illuminating the transmission type display for forming the image to be seen by the user.

The transmission type display may be, for example, a TFT display or an LCD display. The light emitting elements may be, for example, LEDs. The control unit may be a processing unit, which may perform other aspects of the control and/or operation of the display device in general or may be a dedicated processing unit specific for the task. The control unit may be realized as an integrated circuit or may be formed by several sub-units.

In an advantageous embodiment of an aspect of the invention, the control unit is configured to determine the subset of the plurality of light emitting elements in accordance with a predetermined area portion of the light source corresponding to the subset of the plurality of light emitting elements and/or a predetermined number of light emitting elements in the subset of the plurality of light emitting elements.

For a given image, the desired compensation of the deviation of the position of the user's eye(s) from a default position, may be obtained just by shifting the illuminated area of the light source. If the configuration of the light source is of such nature that the light emitting elements are evenly distributed, this basically means that the subset of light emitting elements used may include the same number of light emitting elements, irrespective of the position of the user's eye(s).

In a further advantageous embodiment of an aspect of the invention, the control unit is configured to determine a configuration of the subset of light emitting elements in accordance with an image to be displayed and to determine a position of the subset of the light emitting elements within the light source in accordance with the received information on the eye position of the user.

Different images to be displayed may require different approaches as to the subset of light emitting elements used for illuminating the respective portion of the transmission type display, whereas the position of such subset of light emitting elements relative to the light source in total is determined in view of the information on the user's eye(s).

According to an aspect of the present invention, there is provided a head-up display for superimposing a virtual image onto a view in front of a user, the head-up display includes the display device according to the present invention and an optical system for projecting a light flux transmitted through the transmission type display.

According to another aspect of the present invention, there is provided a vehicle including the head-up display according to the above aspect, and a tracking system for determining an eye position of a user of the vehicle, the tracking system is configured to provide information on the eye position of the user to the control unit of the display device of the head-up display.

According to a further aspect of the invention, a computer program is proposed with computer program code means for causing a control unit of a display device according to the invention to carry out the steps of the method according to the invention, when the computer program is run on the control unit. The computer program may be provided, stored and/or distributed on a suitable medium, such as an optical storage medium or a non-volatile solid-state medium. The computer program may be supplied together with or as part of other hardware, but may also be distributed in other forms, such as via the Internet or other wired or wireless telecommunication systems.

Features of preferred embodiments of the invention are defined, in particular, in the dependent claims, while further advantageous features, embodiments and implementations are apparent to the skilled person from the above explanation and the following discussion.

In the following, the present invention is further elucidated and exemplified under reference to embodiments illustrated in the attached drawings.

### BRIEF DESCRIPTION OF DRAWINGS

FIGS. 1A to 1C show a schematic representations for illustrating situations according to conventional local dimming and according to an aspect of the present invention;

FIG. 2 shows a schematic representation illustrating a relative arrangement in a three dimensional context:

FIG. 3 shows a schematic representation of a head-up display in a moving vehicle; and

FIG. 4 shows a simplified illustration of a computational flow according to an embodiment of the invention.

### DESCRIPTION OF EMBODIMENTS

In the attached drawings and the explanations on these drawings elements, which are in relation or in correspondence, are indicated—where expedient—by corresponding or similar reference signs, regardless of whether or not the elements are part of the same embodiment.

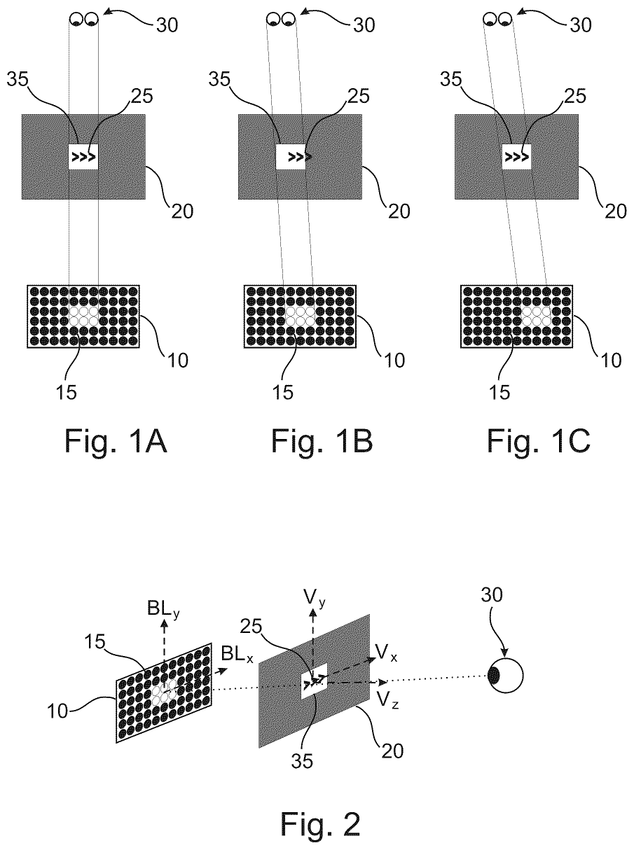

FIGS. 1A to 1C show schematic representations for illustrating a situation in case of conventional local dimming with a basic position (i.e. not misaligned position) of the user, a situation in case of conventional local dimming with a position of the user shifted in comparison to the basic position (i.e. a misaligned position) and a situation with a position shifted in comparison to the basic position, in additional the local dimming, also a compensation for the shift is provided according to the present invention.

In FIGS. 1A to 1C, a light source 10 in form of backlight including a matrix of light emitting diodes (as examples of light emitting elements) 15 is shown together with a TFT display 20, on which an image 25 is displayed.

A subset of the light emitting diodes 15 is operated (i.e. emit light), while the remaining light emitting diodes 15 remain powered off, i.e. do not emit light. Considering a light path from the operated subset of light emitting diodes 15 to an eye position 30 of a user, a portion 35 of the TFT display 20 is illuminated, i.e. light travelling from the subset of light emitting diodes 15 to the eyes of user pass through such portion 35.

In FIGS. 1A to 1C, any additional elements or aspects, e.g. an optical system for directing the light flux, are omitted, so to allow for a simplification focusing on the illustrations of the different situations.

In the case of FIG. 1A, the eye position 30 of the user is substantially centered and the resulting relative arrangement of a centered image 25 and a centered subset of operated light emitting diodes 15 leads to an alignment giving a suitable light distribution, where there is a substantially uniform illumination (i.e. display to the user) of the image 25.

In the case of FIG. 1B, the eye position 30 of the user is shifted in comparison to the case of FIG. 1A, which leads to a portion of the image 25 no longer been illuminated by light travelling from the operated subset of light emitting diodes 15. In other words, due to the shift of the eye position 30 there is also a shift of the illuminated portion 35, resulting in a mis-alignment between the illuminated portion 35 and the image 25.

In the case of FIG. 1C, the eye position 30 of the user is shifted in comparison to the case of FIG. 1A but corresponds to that of the case of FIG. 1B. In FIG. 1C, the position of the operated subset of light emitting diodes 15 is shifted in comparison to the case of FIGS. 1A and 1B, whereas such shift provides that the position of the illuminated portion 35 of the TFT display 20 is adjusted, so to compensated for the shift of the eye position 30, resulting in an alignment of the image 25 and the illuminated portion 35.

While FIGS. 1A to 1C show schematic representations without specifically considering the relative spatial arrangements of the involved elements, FIG. 2 shows a schematic representation which aims at also showing some relative arrangement in a three dimensional context, together with a virtual image display reference plane.

The position of the operated subset of light emitting diodes 15 within the backlight can be indicated, for example, by values of coordinates BLx and BLy of the center of gravity of the subset, as it may already be done in accordance with conventional local dimming approaches.

The coordinate position of the user's eye(s) can be considered in a virtual image display reference plane Vxyz, wherein the eye position 30 can be determined, for example, by making use of information obtained from an eye tracking system (not shown) provided in the vehicle (not shown). Alternatively, a dedicated camera system (or other suitable sensor) may be provided for obtaining such information, even though such additional elements may increase the overall costs the system.

The information of the eye position 30 is used for modifying the position of the illuminated portion 35, i.e. for determining an offset of the local dimming area for compensating the positional shift of the eye position 30.

Under the assumption that the eye position 30 is only shifted along the Vₓ or V_{y} direction, i.e. that there is only an offset or shift ΔVₓ or ΔV_{y} in relation to a reference position, a simplified correlation between the eye position 30 and the corresponding shift of the center of gravity of the operated subset of light emitting diodes may be described as

$$B {L}_{x} = - {∝}_{x} \cdot {V}_{x}$$

$$B {L}_{y} = - {∝}_{y} \cdot {V}_{y}$$

$$with$$

$${a}_{x , y} = f [ {V}_{z} , {Od}_{x , y} ]$$

The factor ax and ay are gain factors that depend on the distance Vz of the virtual image display reference plane from the eye position 30 and the optical design (Odx,y) of the overall system.

It will be appreciated that, while the determination of the influence of the optical design on the amount of compensation may be difficult to describe in general terms, such determination is well within the grasp of the skilled person for any given implementation.

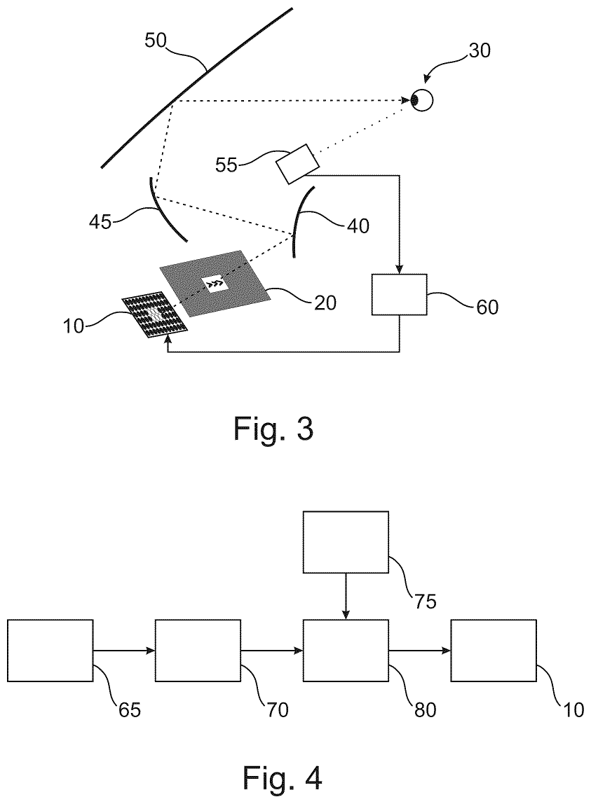

FIG. 3 shows a schematic representation of a head-up display in a moving vehicle as an example of an implementation of the present invention, which may be employed also in other applications, e.g. other types of display arrangements or augmented reality devices.

The head-up display includes the backlight 10 and the TFT display 20 as discussed above. The light transmitted through the TFT display 20 passes an optical system including a first mirror 40 and a second mirror 45, so to be directed to the windshield 50 (or an other reflecting element of the head-up display), for eventually arriving at the eye position 30 of the user. The eye position 30 of the user is determined by means of an eye tracking sensor 55, which may, for example, include a suitable camera. The information on the eye position 30 of the user is provided to a controller 60, which, in turn, controls the local dimming functionality and specifically the adaptation thereof, so to ensure that the light path properly arrives at the eye position 30, even if there is a shift.

The specific configuration of the optical system are not further discussed here, since it is merely an implementational aspect and the present invention may also employed with other configurations. The same applies to other aspects of the head-up display.

FIG. 4 shows a simplified illustration of a computational flow according to an embodiment of the invention, involving an image source 65, a local dimming routine 70, an eye tracking routine 75, an eye position compensation routine 80 and the backlight 10.

The image source 65 provides information on the image to be displayed to the local dimming routine 70. The eye tracking routine 75 obtains a position of the eye(s) of the user.

It may be noted that, generally, the eye position may be described in absolute values or in relative values, referring to, for example, a fixed reference position.

The information as to the eye position from the eye tracking routine 75 and the information as to the local dimming routine 70 are provided to the eye position compensation routine 80, eventually leading to a suitable control of the backlight 10.

Even if in the drawings different aspects or features of the invention are shown in combination, the skilled person will appreciate—unless indicated otherwise—that the combinations shown and discussed are not exhaustive and variations thereof are possible. In particular, corresponding elements or feature complexes may be mutually exchanged between different embodiments.

Upon implementing the invention, single components, e.g. a processor, may fulfill a function or functions of several elements mentioned in the claims. Processes or operations like controlling, determining, and calculating may be realized by means of computer program code means (e.g. code elements, routines or processes) of a computer pro-gram or as dedicated hardware.

### REFERENCE SIGNS LIST

10 light source/backlight
15 light emitting element/light emitting diode
20 transmission type display/TFT display
25 image
30 eye position
35 illuminated portion
40,45 mirror
50 windshield
55 eye tracking sensor
60 controller
65 image source
70 local dimming routine
75 eye tracking routine
80 eye position compensation routine

What is claimed is:

1. A display device suitable for a head-up display, comprising
a transmission type display,
a light source which is spaced apart from the transmission type display and which includes a plurality of light emitting elements, and
a control unit that receives information on an eye position of a user, wherein
the control unit selectively controls the plurality of light emitting elements, so to illuminate a predetermined area corresponding to the eye position of the user through the transmission type display by means of a subset of the plurality of light emitting elements, whereas the light emitting elements of the plurality of light emitting elements other than that the light emitting elements of the subset are turned off or dimmed.

2. The display device according to claim 1,
wherein the control unit is configured to determine the subset of the plurality of light emitting elements in accordance with a predetermined area portion of the light source corresponding to the subset of the plurality of light emitting elements and/or a predetermined number of light emitting elements in the subset of the plurality of light emitting elements.

3. The display device according to claim 1,
wherein the control unit is configured to determine a configuration of the subset of light emitting elements in accordance with an image to be displayed and to determine a position of the subset of the light emitting elements within the light source in accordance with the received information on the eye position of the user.

4. A head-up display for superimposing a virtual image onto a view in front of a user, the head-up display comprising:
the display device according to claim 1,
an optical system for projecting a light flux transmitted through the transmission type display.

5. A vehicle, comprising:
the head-up display according to claim 4, and
a tracking system for determining an eye position of a user of the vehicle,
wherein the tracking system is configured to provide information on the eye position of the user to the control unit of the display device of the head-up display.

6. A method for controlling a display device suitable for a head-up display, wherein the display device comprises a transmission type display, a light source which is spaced apart from the transmission type display and which includes a plurality of light emitting elements, and a control unit for controlling the plurality of light emitting elements, wherein the method comprises:
receiving information on an eye position of a user, and
selectively controlling the plurality of light emitting elements, so to illuminate a predetermined area corresponding to the eye position of the user through the transmission type display by means of a subset of the plurality of light emitting elements, where-as the light emitting elements of the plurality of light emitting elements other than that the light emitting elements of the subset are turned off or dimmed.

7. A computer-readable storage medium that stores a computer program with computer program code means for causing a control unit of a display device suitable for a head-up display to carry out the steps of the method according to claim 6, when the computer program is run on the control unit,
the display device includes
a transmission type display,
a light source which is spaced apart from the transmission type display and which includes a plurality of light emitting elements, and
a control unit that receives information on an eye position of a user, wherein
the control unit selectively controls the plurality of light emitting elements, so to illuminate a predetermined area corresponding to the eye position of the user through the transmission type display by means of a subset of the plurality of light emitting elements, whereas the light emitting elements of the plurality of light emitting elements other than that the light emitting elements of the subset are turned off or dimmed.
